(19) United States
(12) Patent Application Publication
(10) Pub. No.: US 2006/0116939 A1
(43) Pub. Date: Jun. 1, 2006

(54) Set of equipment for the preparation and execution of the financial performance of a business transaction between a seller and a buyer

(76) Inventor: Andras Vilmos, Budapest (HU)

Correspondence Address: SNELL & WILMER;ONE ARIZONA CENTER, 400 EAST VAN BUREN, PHOENIX, AZ, 850040001, US

(21) Appl. No.: 10/518,951

(22) PCT Filed: Dec. 18, 2002
(86) PCT No.: PCT/HU02/00150

§ 371 Date: Sep. 22, 2005

(30) Foreign Application Priority Data
Jun. 17, 2002 (HU) P0202003

(51) Int. Cl. G06Q 40/00

(52) U.S. Cl. 705/35

(57) ABSTRACT

The invention relates to a set of equipment according to the invention for the preparation and execution of the financial performance of a business transaction between a seller and a buyer, which contains an internal communication unit belonging to the seller's financial institution and an internal communication unit belonging to the buyer's financial institution, an information transmission network connecting the internal communication units of the financial institutions, furthermore, an external seller communication unit belonging to the seller and an external buyer communication unit belonging to the buyer, the external seller communication unit and the external buyer communication unit have data transmission channels, the data transmission channel of the external seller communication unit is connected to the internal communication unit of the seller's financial institution and the data transmission channel of the external buyer communication unit is connected to the internal communication unit of the buyer's financial institution. The external buyer communication unit (10) and the external seller communication unit (20) are connected to each other with the assistance of a directed data channel (30) suitable for creating an unambiguous connection between them, which directed data channel (30) is set up so that it is suitable for sending the seller's identification data (2a) and transaction data (2b), the external buyer communication unit (10) has an own-data input part-unit (11), a seller-data receiving part-unit (12), and, furthermore, data unification part-unit (13), the one input (13a) of the data unification part-unit (13) is connected to the own-data input part-unit (11), the other input (13b) of the data-unification part-unit (13) is connected to the seller-data receiving part-unit (12), the output (13c) of the data-unification part-unit (13) is either directly or indirectly connected to the internal communication unit (41) belonging to the buyer's (1) financial institution (40), furthermore, the external seller communication unit (20) has an own-data input part-unit (21), a transaction-data management part-unit (22), furthermore, a data unification part-unit (23), a seller-data sending part-unit (24) and a seller's data-receiving part-unit (25), one input (23a) of the data-unification part-unit (23) is connected to the own-data input part-unit (21), the other input (23b) of the data-unification part-unit (23) is connected to the transaction data management part-unit (22), the seller-data sending part-unit (24) is linked to the seller-data receiving part-unit (12) of the external buyer communication unit (10), and the seller's data-receiving part unit (25) is in either direct or indirect connection with the internal communication unit (51) belonging to the seller's (2) financial institute (50).

The subject of the invention relates to a set of equipment for the preparation and execution of the financial performance of a business transaction between a seller and a buyer which contains an internal communication unit belonging to the seller's financial institution and an internal communication unit belonging to the buyer's financial institution, an information transmission network connecting the internal communication units of the financial institutions,.furthermore, an external seller communication unit belonging to the seller and an external buyer communication unit belonging to the buyer, the external seller communication unit and the external buyer communication unit have data transmission channels, the data transmission channel of the external seller communication unit is connected to the internal communication unit of the seller's financial institution and the data transmission channel of the external buyer communication unit is connected to the internal communication unit of the buyer's financial institution.

The subject of the invention, furthermore, also relates to a set of equipment for the preparation and execution of the financial performance of a business transaction between a seller and a buyer that contains an internal communication unit belonging to the financial institution that is the same for both the buyer and the seller, furthermore, an external seller communication unit belonging to the seller and an external buyer communication unit belonging to the buyer, the external seller communication unit and the external buyer communication unit have data transmission channels, the data transmission channel of the external seller communication unit and the data transmission channel of the external buyer communication unit are connected to the internal communication unit of the financial institution.

Today, with the rapid development of computing and mobile telecommunications, cash-free financial transactions linked to purchases are becoming increasingly wider spread that are realised using some sort of data network. These include account settlement with the assistance of the so-called “POS terminal”, as well as the financial offsetting of purchases made on the Internet. Among others, such solutions can be seen in patent description registration number HU 218.646, and in international publication document number WO 00/23928.

Furthermore, international publication document number WO 95/12859 relates to the settlement of accounts, the essence of which is that the seller, who issues the invoice, issues the invoice on the basis of data received from the buyer and then sends it to the buyer's bank, which settles the invoice amount by bank transfer. In general this solution may be used for the continuous settling of public utility invoices.

The disadvantage of the solution, however, is that the settlement of the invoice takes place essentially automatically, so the buyer, before the transfer, has no way of checking the rightfulness of the invoice nor to check the correctness of the amount and refuse the settlement of the invoice, as the buyer only knows about the payment of the amount after it has taken place.

A further disadvantage is that the issuer of the invoice obtains the buyer's data, which, in a given case, may form the basis for abuses to be committed.

By setting up the set of equipment according to the invention our aim was to overcome the disadvantages occurring when executing the known cash-free financial transactions and to create a solution with the help of which the personal and important confidential data of the seller and the buyer remain secure, inaccessible to unauthorised parties, and before the actual execution of the financial transaction an authentication procedure can be run between the buyer and the seller.

The recognition that led to the set of equipment according to the invention was that if the external communication unit at the seller and the external communication unit at the buyer are set up in a novel way and contrary to the known solutions we make these suitable for carrying out direct data communication with each other, then the task can be solved.

In accordance with the set aim the set of equipment according to the invention for the preparation and execution of the financial performance of a business transaction between a seller and a buyer, which contains an internal communication unit belonging to the seller's financial institution and an internal communication unit belonging to the buyer's financial institution, an information transmission network connecting the internal communication units of the financial institutions, furthermore, an external seller communication unit belonging to the seller and an external buyer communication unit belonging to the buyer, the external seller communication unit and the external buyer communication unit have data transmission channels, the data transmission channel of the external seller communication unit is connected to the internal communication unit of the seller's financial institution and the data transmission channel of the external buyer communication unit is connected to the internal communication unit of the buyer's financial institution, is set up in such a way that the external buyer communication unit and the external seller communication unit are connected to each other with the assistance of a directed data channel suitable for creating an unambiguous connection between them, which directed data channel is set up so that it is suitable for sending the seller's identification data and transaction data, the external buyer communication unit has an own-data input part-unit, a seller-data receiving part-unit, and, furthermore, a data unification part-unit, the one input of the data unification part-unit is connected to the own-data input part-unit, the other input of the data-unification part-unit is connected to the seller-data receiving part-unit, the output of the data-unification part-unit is either directly or indirectly connected to the internal communication unit belonging to the buyer's financial institution, furthermore, the external seller communication unit has an own-data input part-unit, a transaction-data management part-unit, furthermore, a data unification part-unit, a seller-data sending part-unit and a seller's data-receiving part-unit, one input of the data-unification part-unit is connected to the own-data input part-unit, the other input of the data-unification part-unit is connected to the transaction-data management part-unit, the seller-data sending part-unit is linked to the seller-data receiving part-unit of the external buyer communication unit, and the seller's data-receiving part unit is in either direct or indirect connection with the internal communication unit belonging to the seller's financial institute.

A further criterion of the set of equipment according to the invention is that one or more data centres are inserted into the information transmission network, and all the data centres are fitted with communication units for the receiving, processing and forwarding of information. A data-transmission and operation-performing unit suitable for receiving, processing and forwarding information is inserted into the information transmission network, and the data-transmission and operation-performing unit is linked to the accounting bank.

From the point of view of the solution it may be favourable if the external buyer communication unit has an information-receiving part-unit for receiving data arriving from the buyer's financial institution. The data-transmission channel between the external buyer communication unit and the internal communication unit belonging to the buyer's financial institution is supplied with at least one wireless signal-transmission device. The data-transmission channel between the external seller communication unit and the internal communication unit belonging to the seller's financial institution is supplied with at least one wireless signal-transmission device.

In one version of the set of equipment the information transmission network between the internal communication unit of the seller's financial institution and the internal communication unit of the buyer's financial institution, and/or the data-transmission channel between the external buyer communication unit and the internal communication unit of the buyer's financial institution and/or the data-transmission channel between the external seller communication unit and the internal communication unit of the seller's financial institution have one or more encryption part-units.

Also in accordance with the set aim the set of equipment according to the invention for the preparation and execution of the financial performance of a business transaction between a seller and a buyer, which contains an internal communication unit belonging to the financial institution that is the same for both the buyer and the seller, furthermore, an external seller communication unit belonging to the seller and an external buyer communication unit belonging to the buyer, the external seller communication unit and the external buyer communication unit have data transmission channels, the data transmission channel of the external seller communication unit and the data transmission channel of the external buyer communication unit are connected to the internal communication unit of the financial institution, is set up in such a way that the external buyer communication unit and the external seller communication unit are connected to each other with the assistance of a directed data channel suitable for creating an unambiguous connection between them, the external buyer communication unit has an own-data input part-unit, a seller-data receiving part-unit, and, furthermore, a data unification part-unit, the one input of the data unification part-unit is connected to the own-data input part-unit, the other input of the data-unification part-unit is connected to the seller-data receiving part-unit, the output of the data-unification part-unit is either directly or indirectly connected to the internal communication unit belonging to the financial institution, furthermore, the external seller communication unit has an own-data input part-unit, a transaction-data management part-unit, a data unification part-unit, a seller-data sending part-unit and a seller's data-receiving part-unit, one input of the data-unification part-unit is connected to the own-data input part-unit, the other input of the data-unification part-unit is connected to the transaction-data management part-unit, the seller-data sending part-unit is linked to the seller-data receiving part-unit of the external buyer communication unit, and the seller's data-receiving part unit is in either direct or indirect connection with the internal communication unit belonging to the financial institute.

From the point of view of the set of equipment it may be favourable if the external buyer communication unit has an own-data register connected to the own-data input part-unit.

In an advantageous construction form of the invention the external seller communication unit has an own-data register connected to the own-data input part-unit, and furthermore, the external seller communication unit has a transaction identifier production module. The external seller communication unit has a seller-data receiving part-unit.

In a still further realisation of the set of equipment in the directed data channel between the external buyer communication unit and the external seller communication unit there is at least one wireless signal-transmission device built in.

In a further embodiment of the invention the external buyer communication unit and/or the external seller communication unit are supplemented with a wireless signal-transmission device.

In a still different embodiment of the set of equipment there are one or more encryption part-units fitted in the directed data channel between the external buyer communication unit and the external seller communication unit.

In a further, different embodiment of the invention the internal communication unit of the financial institution is connected to an information transmission network, there are one or more data centres inserted in the information transmission network, and all of the data centres are fitted with communication units for receiving, processing and forwarding information. A data-transmission and operation-performing unit suitable for receiving, processing and forwarding information is inserted into the information transmission network, and the data-transmission and operation-performing unit is linked to the accounting bank.

In a favourable realisation of the set of equipment the data-transmission channel between the internal communication unit of the seller's and the buyer's financial institution and the external buyer communication unit and/or the external seller communication unit has one or more encryption part-units. The external buyer communication unit has an information-receiving part-unit for receiving data arriving from the financial institution.

In a further embodiment of the invention the data-transfer channel between the external buyer communication unit and the internal communication unit belonging to the buyer's financial institution there is at least one wireless signal transmission device. The data-transmission channel between the external seller communication unit and the internal communication unit belonging to the seller's financial institution is supplied with at least one wireless signal-transmission device.

The most important advantage of the set of equipment according to the invention is that due to the new use of the external buyer communication unit and the external seller communication unit, furthermore, the novel, direct connection between the two there is the possibility when preparing and executing the financial transaction of a sale for it to be unnecessary for the seller and the buyer to exchange confidential, personal data. As a consequence of this there is not even the risk of an unauthorised person being able to abuse this information, in other words the bank account number, personal identification number or password and other similar data

Another advantage is that due to the new set of equipment the preparation of the financial transaction, in other words the check and authentication in advance of the movement of the money can be completed in a short time. So in essence the purchase can be seen as a real-time sale, which greatly increases the buyer's and seller's feeling of security with respect to that neither the buyer nor the seller suffers loss or discomfort in connection with the execution of the business deal.

It is also favourable that the majority of the elements of the set of equipment can be produced simply, and the functional changes can be carried out under favourable condition with favourable costs. Another advantage deriving from this is that following carrying out the appropriate transformations and supplementation the network that had been operated previously and its elements remain usable for carrying out financial transactions. They will even be able to carry out the “administrative” authentication and checking tasks previous to the financial operations quickly and efficiently, which improves the usability of the system.

In the following we present the invention in more detail in connection with construction examples, on the basis of drawings. On the drawing

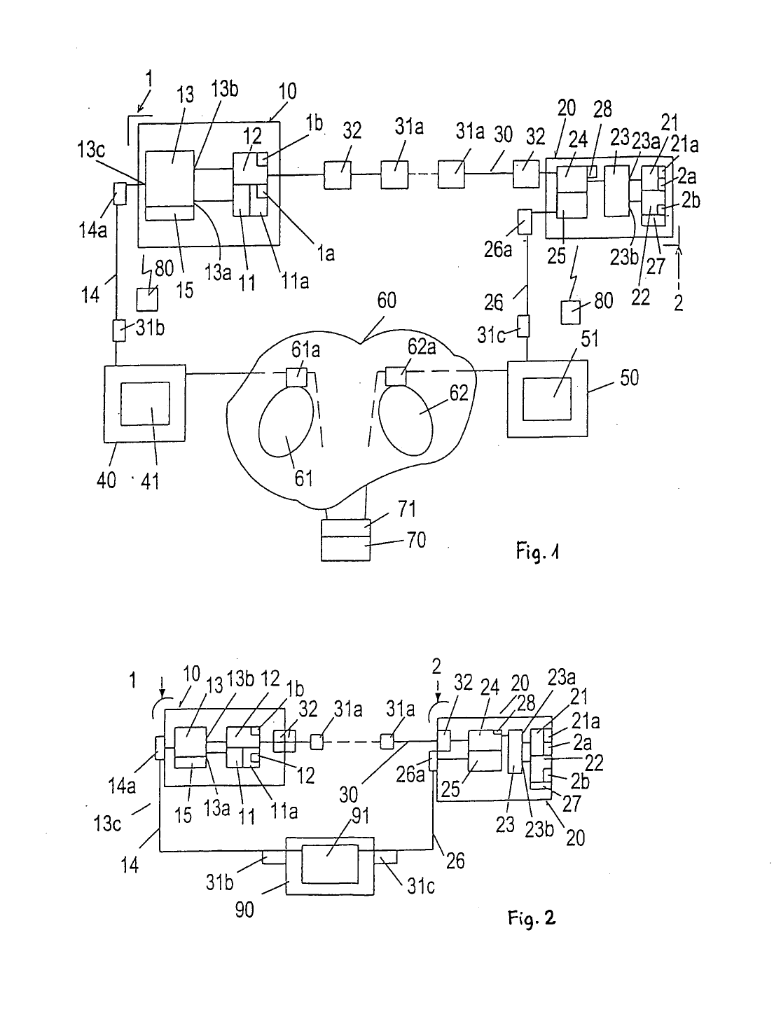

FIG. 1 is the block-outline of a possible arrangement of the set of equipment according to the invention,

FIG. 2 is another arrangement of the set of equipment.

FIG. 1 shows a construction example of the set of equipment according tot he invention in which the buyer's 1 financial institution 40 and the seller's 2 financial institution 50 are not the same, so between the internal communication unit 41 of the buyer financial institution 40 and the internal communication unit 51 of the seller financial institution 50 the information transmission network 60 creates the connection. This information transmission network 60 contains the data centre 61, which with the help of the communication unit 61a is connected with the internal communication unit 41 of the buyer financial institution 40. The information transmission network 60 may also have another data centre 62, which is in connection with the internal communication unit 51 of the seller financial institution 50 via the communication unit 62a. For the latter solution it is sufficient if the internal communication unit 51 of the seller financial institution 50 and the internal communication unit 41 of the buyer financial institution 40 are connected with the same data centre's 61 communication unit 61a.

In this construction example the data centre's 61 communication unit 61a and the data centre's 62 communication unit 62a are connected to the accounting bank 70 via the data-transmission and operation-performing unit 71. Naturally numerous data centres similar to the data centres 61 and 62 may appear in the information transmission network 60, all of which are connected to financial service providers similar to the buyer financial institution 40 and the seller financial institution 50, but for simplicity we have only shown one buyer financial institution 40 and one seller financial institution 50.

It is also obvious that for the appropriate operation of the set of equipment according to the invention it is not absolutely necessary to have the accounting bank 70, but it may be favourable from the point of view of carrying out the transactions.

Here we also have to mention that the information transmission network 60 may be any communication system. So a line data-transmission network or a wireless network or a combination of these can be considered. Their essence is that, irrespective of their construction, they send the necessary signal groups at the desired speed and reliability level from the internal communication unit 41 of the buyer financial institution 40 to the internal communication unit 51 of the seller financial institution 50 and back.

On FIG. 1 it can also be seen that the buyer 1 has an external buyer communication unit 10, while the seller 2 has an external seller communication unit 20. The external buyer communication unit 10 is physically in the possession of the buyer 1, and the external seller communication unit 20 is in the possession of the seller 2.

With the help of the directed data channel 30 the external buyer communication unit 10 and the external seller communication unit 20 are temporarily connected in such a way as to be suitable for the transmission of information. In the interest of the protection of data encryption part-units 32 may be inserted into the directed data channel 30. The encryption part-units 32 may be physically positioned in the directed data channel 30, but they may also be a part of the external buyer communication unit 10 and the external seller communication unit 20 as well. It is obvious that the position of the encryption part-units 32 is unimportant. It is important, however, that by using them the data flowing on the directed data channel 30 become protected against unauthorised information acquisition. The directed data channel 30 may also contain one or more signal-transmission devices 31a, e.g. radiotelephone or mobile data transmission device, which make the realisation of the communication easier.

The directed data channel 30 is connected to the seller-data receiving part-unit 12 of the external buyer communication unit 10, which contains the transaction information 1b.

The own-data input part-unit 11 is also part of the external buyer communication unit 10, which is connected to the own-data register 11a. The own-data register 11a contains the buyer identification data 1a.

The own-data input part-unit 11 is connected to the data-unification part-unit 13 through the one input 13a, while the seller-data receiving part-unit 12 is connected to the other input 13b. The output 13c of the data-unification part-unit 13 is connected to the internal communication unit 41 of the buyer financial institution 40 through the data-transmission channel 14. The data-transmission channel 14 is suitable for carrying out bi-directional data traffic, and this can be line or wireless. The data-transmission channel 14 has an encryption part-unit 14a and in a given case a wireless signal-transmission device 31b.

The task of the encryption part-unit 14a is to protect the information between the external buyer communication unit 10 and the buyer financial institution 40 from unauthorised parties, in other words to create and maintain the possibility of secure data traffic. In the interest of fast data traffic the wireless signal-transmission device 31b may be a necessary part of the data-transmission channel 14. The external buyer communication unit 10 is supplied with an information-receiving part-unit 15 positioned between the data-transmission channel 14 and the data-unification part-unit 13 so that it is also suitable for handling the information arriving from the buyer financial institution 40.

The situation has to be emphasised that the external buyer communication unit's 10 own-data input part-unit 11, seller-data receiving part-unit 12, data-unification part-unit 13 and information-receiving part-unit 15 can be integrated into a single unit, it can even be formed as a mini computer, which greatly simplifies the positioning and use of the external buyer communication unit 10.

The seller's 2 external seller communication unit 20 includes the own-data input part-unit 21 that has an own-data register 21a containing the seller identification data 2a, the transaction-data management part-unit 22 that can be loaded with transaction data 2b, the transaction identifier production module 27, the data-unification part-unit, and furthermore, the seller-data sending part-unit, the seller's data-receiving part-unit 25 and the seller-data receiving part-unit 28. The one input 23a of the data-unification part-unit 23 is connected with the own-data input part-unit 21, and the other input 23b of the data-unification part-unit 23 with the transaction-data management part-unit 22. The transaction identifier production module 27 is connected to the transaction data management part-unit 22, while the buyer-data receiving part-unit 28 is paired with the seller-data sending part-unit 24 and is connected to the data-unification part-unit 23.

The seller-data sending part-unit 24 of the external seller communication unit 20 is connected to the directed data channel 30, while the seller's data-receiving part-unit 25 connects to the internal communication unit 51 of the seller financial institution 50 via the data-transmission channel 26. The data-transmission channel 26 has an encryption part-unit 26a and, in a given case, a wireless signal-transmission device 31c. The wireless signal-transmission device 31c creates the opportunity for the external seller communication unit 20 to be constructed so that it may be moved about, or even be portable.

Also in the interest of easier operation external seller communication unit 20 has a wireless signal-transmission member 80, which may be a mobile telephone. The wireless signal-transmission member 80 operating with the external buyer communication unit 10 has a similar role, which may also be a mobile telephone.

A solution may also be imagined in which the external buyer communication unit 10 is built into the wireless signal-transmission member 80, and the wireless signal-transmission member 80 takes over the role of the wireless signal-transmission device 31a. In an optimum case the external buyer communication unit 10 fitted in the wireless signal-transmission member 80 appears to the buyer 1 as a service provided by a mobile telephone, and so the external buyer communication unit 10 is always to be found on the user's person. Naturally the external seller communication unit 20 and the wireless signal-transmission member 80 can be built together into a single, even mobile structure.

Obviously a version can be realised where the external buyer communication unit 10 and the external seller communication unit 20 are individual computers. This solution is advantageous if the sale takes place on the Internet. Although the inadequacy of such a set-up of the set of equipment is that the external buyer communication unit 10 loses its mobility.

When using the set of equipment according to FIG. 1 the buyer 1 loads the buyer identification data 1a characteristic of the buyer 1 and required for carrying out the financial transaction into the own-data register 11a of the own-data input part-unit 11 of the external buyer communication unit 10, while the seller 2 loads the seller identification data 2a that relates to the seller 2 and that is essential for the realisation of the financial transaction into the own data register 21a of the own-data input part-unit of the external seller communication unit 20.

After loading the external buyer communication unit 10 and the external seller communication unit 20 in this way when the sale, created in one way or another, between the buyer 1 and the seller 2 takes place the transaction identifier production module 27 of the external seller communication unit 20 generates transaction data that goes to the transaction data management part-unit 22. The transaction data 2b are, on the one part, stored in the transaction data management part-unit and, on the other part, go to the data-unification part-unit 23 via the other input 23b of the data-unification part-unit 23.

The seller identification data 2a stored in the own-data register 21a of the own-data input part-unit also goes to the data-unification part-unit 23, only via its one input 23a. From the seller identification data 2a and the transaction data 2b the data-unification part-unit 23 creates a message, which it sends to the seller-data sending part-unit 24, and encrypted in the encryption part-unit, with the help of the directed data channel it sends to the encryption part-unit 32 connected to the seller-data receiving part-unit 12 of the external buyer communication unit 10. The encryption part-unit 32 decodes the message and sets up the transaction information 1b in the seller-data receiving part-unit 12, which contains the parameters characteristic of the sale, e.g. the data for transferring the purchase price to the seller 2.

The seller-data receiving part-unit 12 of the external buyer communication unit 10 sends the transaction information 1b to the data-unification part-unit 13 via the other input 13b of the data-unification part-unit 13, while it sends the buyer identification data 1a stored in the own-data register 11a of the own-data input part-unit through the one input 13a to the data-unification part-unit 13. From the buyer identification data 1a and the transaction information 1b the data-unification part-unit 13 creates a message with the help of which the buyer's 1 buyer financial institution 40 is able to identify the buyer 1, the seller's 2 seller financial institution 50 and the amount to be transferred, together with any desired message.

When this message has been set up then the data-unification part-unit 13 encrypts the message with the help of the encryption part-unit and sends it via the data-transmission channel 14 to the internal communication unit 41 of the buyer financial institution. Here, on the basis of the message the buyer financial institution 40 sends the message to the internal communication unit 51 of the identified seller financial institution 50 over the information transmission network 60 and within this via the data centre 61 and possibly with the inclusion of the data centre 62.

On the basis of the message received the internal communication unit 51 of the seller financial institution 50 determines the seller 2 and sends the message via the data-transmission channel 26 to the seller's 2 data-receiving part-unit 25 of the external seller communication unit 20 belonging to the seller 2. The message sent to the external seller communication unit 20 also contains the transaction data 2b sent from the seller 2, with this the content of the message can be checked.

If the data in the message received, especially the amount intended to be transferred agrees with the data stored in the seller's 2 external seller communication unit 20, then the external seller communication unit 20 sends a reply message encrypted with the help of the encryption part-unit 26a via the data-transmission channel 26 to the seller financial institution 50, which send this message back to the buyer financial institution 40. Following this the buyer financial institution 40 carries out the financial transaction regarding which it sends a confirmation message with the help of the data-transmission channel 14 to the information-receiving part-unit 15 of the buyer's 1 external buyer communication unit 10.

Here we have to mention that in a given case the external buyer communication unit 10 may also send back the message, or a part of it, sent into the data-transmission channel 14 and made by the data-unification part-unit 13, apart from to the seller financial institution 40, to the buyer-data receiving part-unit 28 of the external seller communication unit 20 with the help of the directed data channel 30. Then later the original message sent to the buyer-data receiving part-unit 28 can be compared with the content of the message generated by the external buyer communication unit 10 sent to the external seller communication unit 20 on the buyer financial institution 40—information transmission network 60—seller financial institution 50—seller's data-receiving part-unit 25 route.

The content of FIG. 2 is essentially the same as the set of equipment appearing in FIG. 1 only with the basic difference that the buyer 1 and the seller 2 belong to the same financial institution 90. As a consequence of this the preparatory message chain previous to the financial transaction is significantly shorter, and so there is no need for the information transmission network presented in the first example. In actual fact the information transmission network is set up in the internal communication unit 91 of the financial institution 90, which is, in essence, only a virtual information transmission network 60.

Disregarding this difference the operation of the set of equipment according to FIG. 2 is the same as the solution discussed in connection with FIG. 1, so we will not discuss this in more detail.

Naturally it may be that from the point of view of the operation of the set of equipment the encryption part-unit 32, the encryption part-unit 14a and the encryption part-unit 26a are unnecessary, and the wireless signal-transmission device 31a, the wireless signal-transmission device 31b and the wireless signal-transmission device 31c may also not be essential requirements. However, their existence significantly simplifies the use of the set of equipment and makes it more secure from a data protection point of view.

The set of equipment according to the invention can be applied well for the reliable and fast preparation and possibly execution of cash-free financial transactions occurring during in connection with purchases.

1. A set of equipment according to the invention for the preparation and execution of the financial performance of a business transaction between a seller and a buyer, which contains an internal communication unit belonging to the seller's financial institution and an internal communication unit belonging to the buyer's financial institution, an information transmission network connecting the internal communication units of the financial institutions, furthermore, an external seller communication unit belonging to the seller and an external buyer communication unit belonging to the buyer, the external seller communication unit and the external buyer communication unit have data transmission channels, the data transmission channel of the external seller communication unit is connected to the internal communication unit of the seller's financial institution and the data transmission channel of the external buyer communication unit is connected to the internal communication unit of the buyer's financial institution characterised by that the external buyer communication unit (10) and the external seller communication unit (20) are connected to each other with the assistance of a directed data channel (30) suitable for creating an unambiguous connection between them, which directed data channel (30) is set up so that it is suitable for sending the seller's identification data (2a) and transaction data (2b), the external buyer communication unit (10) has an own-data input part-unit (11), a seller-data receiving part-unit (12), and, furthermore, a data unification part-unit (13), the one input (13a) of the data unification part-unit (13) is connected to the own-data input part-unit (11), the other input (13b) of the data-unification part-unit (13) is connected to the seller-data receiving part-unit (12), the output (13c) of the data-unification part-unit (13) is either directly or indirectly connected to the internal communication unit (41) belonging to the buyer's (1) financial institution (40), furthermore, the external seller communication unit (20) has an own-data input part-unit (21), a transaction-data management part-unit (22), furthermore, a data unification part-unit (23), a seller-data sending part-unit (24) and a seller's data-receiving part-unit (25), one input (23a) of the data-unification part-unit (23) is connected to the own-data input part-unit (21), the other input (23b) of the data-unification part-unit (23) is connected to the transaction-data management part-unit (22), the seller-data sending part-unit (24) is linked to the seller-data receiving part-unit (12) of the external buyer communication unit (10) and the seller's data-receiving part-unit (25) is in either direct or indirect connection with the internal communication unit (51) belonging to the seller's (2) financial institute (50).

2. The set of equipment according to claim 1 characterised by that one or more data centres (61, 62) are inserted into the information transmission network (60), and all the data centres (61, 62) are fitted with communication units (61a, 62a) for the receiving, processing and forwarding of information.

3. The set of equipment according to claim 1 characterised by that a data-transmission and operation-performing unit (71) suitable for receiving, processing and forwarding information is inserted into the information transmission network (60), and the data-transmission and operation-performing unit (71) is linked to the accounting bank (70).

4. The set of equipment according to claim 1 characterised by that the external buyer communication unit (10) has an information-receiving part-unit (15) for receiving data arriving from the buyer's financial institution (40).

5. The set of equipment according to claim 1 characterised by that the data-transmission channel (14) between the external buyer communication unit (10) and the internal communication unit (41) belonging to the buyer's (1) financial institution (40) is supplied with at least one wireless signal-transmission device (31b).

6. The set of equipment according to claim 1 characterised by that the data-transmission channel (26) between the external seller communication unit (20) and the internal communication unit (51) belonging to the seller's (2) financial institution (50) is supplied with at least one wireless signal-transmission device (31c).

7. The set of equipment according to claim 1 characterised by that the information transmission network (60) between the internal communication unit (51) of the seller's (2) financial institution (50) and the internal communication unit (41) of the buyer's (1) financial institution (40) and/or the data-transmission channel (14) between the external buyer communication unit (10) and the internal communication unit (41) of the buyer's (1) financial institution (40) and/or the data transmission channel (26) between the external seller communication unit (20) and the internal communication unit (51) of the seller's (2) financial institution (50) have one or more encryption part-units (14a, 26a).

8. The set of equipment according to the invention for the preparation and execution of the financial performance of a business transaction between a seller and a buyer, which contains an internal communication unit belonging to the financial institution that is the same for both the buyer and the seller, furthermore, an external seller communication unit belonging to the seller and an external buyer communication unit belonging to the buyer, the external seller communication unit and the external buyer communication unit have data transmission channels, the data transmission channel of the external seller communication unit and the data transmission channel of the external buyer communication unit are connected to the internal communication unit of the financial institution characterised by that the external buyer communication unit (10) and the external seller communication unit (20) are connected to each other with the assistance of a directed data channel (30) suitable for creating an unambiguous connection between them, which directed data channel (30) is set up to be suitable for sending seller identifier data (2a) and transaction data (2b), the external buyer communication unit (10) has an own-data input part-unit (11), a seller-data receiving part-unit (12), and, furthermore, a data unification part-unit (13), the one input (13a) of the data unification part-unit (13) is connected to the own-data input part-unit (11), the other input (13b) of the data-unification part-unit (13) is connected to the seller-data receiving part-unit (12), the output (13c) of the data-unification part-unit (13) is either directly or indirectly connected to the internal communication unit (91) belonging to the financial institution (90), furthermore, the external seller communication unit (20) has an own-data input part-unit (21), a transaction-data management part-unit (22), a data unification part-unit (23), a seller-data sending part-unit (24) and a seller's data-receiving part-unit (25), one input (23a) of the data-unification part-unit (23) is connected to the own-data input part-unit (21), the other input (23b) of the data-unification part-unit (23) is connected to the transaction-data management part-unit (22), the seller-data sending part-unit (24) is linked to the seller-data receiving part-unit (12) of the external buyer communication unit (10), and the seller's data-receiving part-unit (25) is in either direct or indirect connection with the internal communication unit (91) belonging to the financial institute (90).

9. The set of equipment according to claim 1 characterised by that the external buyer communication unit (10) has an own-data register (11a) connected to the own-data input part-unit (11).

10. The set of equipment according to claim 1 characterised by that the external seller communication unit (20) has an own-data register (21a) connected to the own-data input part-unit (21).

11. The set of equipment according to claim 1 characterised by that the external seller communication unit (20) has a transaction identifier production module (27).

12. The set of equipment according to claim 1 characterised by that the external seller communication unit (20) has a seller-data receiving part-unit (28).

13. The set of equipment according to claim 1 characterised by that the directed data channel (30) between the external buyer communication unit (10) and the external seller communication unit (20) there is at least one wireless signal-transmission device built in (31a).

14. The set of equipment according to claim 1 characterised by that the external buyer communication unit (10) and/or the external seller communication unit (20) are supplemented with a wireless signal-transmission device (80).

15. The set of equipment according to claim 1 characterised by that there are one or more encryption part-units (32) fitted in the directed data channel (30) between the external buyer communication unit (10) and the external seller communication unit (20).

16. The set of equipment according to claim 8 characterised by that the internal communication unit (91) of the financial institution (90) is connected to an information transmission network (60), there are one or more data centres (61, 62) inserted in the information transmission network (60), and all of the data centres (61, 62) are fitted with communication units (61a, 62a) for receiving, processing and forwarding information.

17. The set of equipment according to any of claims 16 characterised by that a data-transmission and operation-performing unit (71) suitable for receiving, processing and forwarding information is inserted into the information transmission network (60), and the data-transmission and operation-performing unit (71) is linked to the accounting bank (70).

18. The set of equipment according to claim 8 characterised by that the data-transmission channel (26) between the internal communication unit (91) of the seller's (2) and the buyer's (1) financial institution (90) and the external buyer communication unit (10) and/or the external seller communication unit (20) has one or more encryption part-units (14a, 26a).

19. The set of equipment according to claim 8 characterised by that the external buyer communication unit (10) has an information-receiving part-unit (15) for receiving data arriving from the financial institution (90).

20. The set of equipment according to claim 8 characterised by that the data-transfer channel (14) between the external buyer communication unit (10) and the internal communication unit (91) belonging to the buyer's (1) financial institution (90) there is at least one wireless signal transmission device (31b).

21. The set of equipment according to claim 8 characterised by that the data-transmission channel (26) between the external seller communication unit (20) and the internal communication unit (91) belonging to the seller's (2) financial institution (90) is supplied with at least one wireless signal-transmission device (31c).
